(19) United States
(12) Patent Application Publication
(10) Pub. No.: US 2022/0270184 A1
(43) Pub. Date: Aug. 25, 2022

(54) REVENUE DISTRIBUTION SYSTEM

(71) Applicant: KEVIN SAFFER, ARRIBA, CO (US)

(72) Inventor: KEVIN SAFFER, ARRIBA, CO (US)

(73) Assignee: OPEN A INC., Sheridan, WY (US)

(21) Appl. No.: 17/180,694

(22) Filed: Feb. 19, 2021

(51) Int. Cl. G06Q 50/00; G06Q 30/02; G06Q 20/40; G06Q 20/38; G06Q 20/12; G06Q 10/08; G06Q 30/06; G06F 16/901; G06F 16/11

(52) U.S. Cl. CPC G06Q 50/01; G06Q 30/0226; G06Q 20/405; G06Q 20/384; G06Q 20/1235; G06Q 10/087; G06Q 30/0641; G06Q 30/0201; G06F 16/9024; G06F 16/116

(57) ABSTRACT

A computer program product, method, and system for tracking user data across a social network is provided. The product is adapted to receive a native data file having attributes assigned to member name, member connections, and temporal information for the connections. The product assigns a weight value to the attributes in the native data file, creates a derivative data file and derivative structure for display based on the weight value assigned to the temporal information. The method includes distributing revenue received from the system to a group of users according to the distribution schedule. The system includes a computer in communication with a network, a memory, and a processor that executes components stored in the memory. The components include a seller module in communication with a seller database, buyer database, and revenue database; and a promoter module in communication with an item database, member database, and promoter database.

### FIELD

The present disclosure relates to a system and method for tracking user data across an online or web-based social network, converting the social network into an online business network, and utilizing the business network to track user activity data, evaluate the contributions by each user to the business network, and reward a predetermined number of users based on their contributions to the business network.

### BACKGROUND

Host companies of online social networks generally aggregate the data from users to produce a data product that can be sold to produce revenue for the host company. Data aggregated in such a form is typical for a shareholder model, which produces value for the shareholders of the host company. But this model disregards the value each individual user creates or contributes to the social network and channels the value to the parent company in a centralized fashion. For the foregoing reasons, there is a need for a system and method for distributing revenue to the stakeholders who are responsible for creating value for the host company.

### SUMMARY

A computer program product embodied on a non-transitory computer readable medium, the computer program comprising computer code adapted to be executed by a computer to perform a method comprising: receiving a native data file comprising a list of members of an online social network, the native data file being adapted and configured to provide a social graph structure of the members for display, wherein the native data file comprises attributes assigned to a member name, a member-to-member connection, and a temporal information associated with the member-to-member connection, and the social graph structure for display is based on the attributes assigned to the member name and the member-to-member connection; assigning a weight value to each of the attributes in the native data file to represent a relative mathematical importance and to emphasize one or more predetermined attributes; transforming the native data file into a first derivative data file that is adapted and configured to display a first derivative structure of the members based on the weight values assigned to each of the attributes in the native data file, including the member name, the member-to-member connection, and the temporal information associated with the member-to-member connection; and providing as a first business network the first derivative structure for each member of the native data file based on the weight value assigned to the temporal information associated with the member-to-member connection

A computer implemented method, comprising: providing an online social network system; receiving revenue to be distributed among one or more users of the online social network system; collecting data associated with the revenue received; determining which users of the one or more users are associated with the revenue received; determining a plurality of attributes for each of the one or more users; wherein, for each particular attribute of the plurality of attributes, calculating a metric value for each of the one or more users who have the particular user attribute, based on the collected data; determining a plurality of revenue distribution rules based on the calculated metric value for the one or more users having the user attribute; storing the determined plurality of revenue distribution rules; generating a revenue distribution schedule by examining the stored plurality of revenue distribution rules; and distributing the revenue received to the one or more users according to the revenue distribution schedule.

A system for tracking user data across an online business network, comprising: at least one computing device in operable communication with a network; a memory that stores computer-executable instructions; a processor in communication with the memory and configured to execute the computer-executable instructions, wherein the computer-executable instructions invoke one or more application program components, comprising: an e-commerce engine configured to execute one or more inputs from a buyer, seller, and/or owner, and transmit the one or more inputs to one or more further application program components; a seller module providing a user interface for selling an item; for displaying an item for sale on an e-commerce marketplace user interface, and for responding to a buyer initiating a process for purchasing the item; an ambassador module providing a user interface for promoting the item or the e-commerce marketplace; a seller database for storing data associated with the item offered for sale; a buyer database for storing data associated with a buyer and a transaction; a revenue database for storing data associated with the sale of the item; an item database for storing data associated with the items offered for sale; a member database for storing data associated with a user of the system; and an ambassador database for storing data associated with a promoter's effort to promote the sale of the item or the system; wherein the computer-executable instructions comprise: providing an online social network system; receiving revenue to be distributed among one or more users of the online social network system; collecting data associated with the revenue received; determining which users of the one or more users are associated with the revenue received; determining a plurality of attributes for each of the one or more users; wherein, for each particular attribute of the plurality of attributes, calculating a metric value for each of the one or more users who have the particular user attribute, based on the collected data; determining a plurality of revenue distribution rules based on the calculated metric value for the one or more users having the user attribute; storing the determined plurality of revenue distribution rules; generating a revenue distribution schedule by examining the stored plurality of revenue distribution rules; and distributing the revenue received to the one or more users according to the revenue distribution schedule.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a block diagram of a computing system, in accordance with embodiments described herein;

FIG. 2A is a block diagram of an application program that is executable by the computing system of FIG. 1;

FIG. 2B is a block diagram of the application program in FIG. 2A;

FIG. 3 is a diagram of representing an example graph data structure of a social network, based on various models known in the prior art;

FIG. 4 is a flow diagram of a network conversion algorithm, in accordance with embodiments described herein;

FIG. 5A includes the table 500a showing a list of connections for certain members of a social network, in accordance with embodiments described herein;

FIG. 5B includes the tables 500b, 500c, and 500d, each showing certain attributes for three members of the business network, in accordance with embodiments described herein;

FIG. 5C includes the tables 500e, 500f, 500g, and 500h, each showing certain attributes for certain members of the business network, in accordance with FIG. 5B;

FIG. 6 is a flowchart of a process, in accordance with some embodiments described herein;

FIG. 7 is a flowchart of a process, in accordance with some embodiments described herein; and

FIG. 8 shows the tables 800a and 800b, each showing certain attributes for members of the business network, in accordance with some embodiments described herein.

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

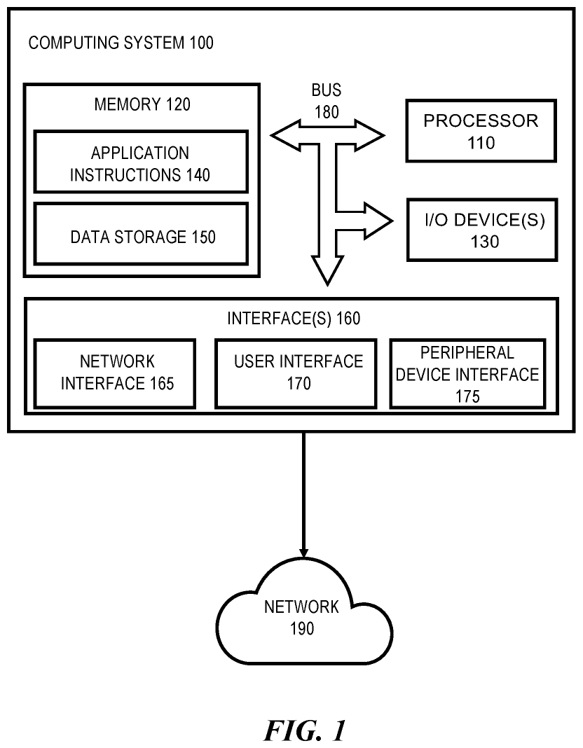

As shown in FIGS. 1-8, the embodiments in this disclosure relate to systems and processes for converting an online social network of users into an online business network of users through the application of a network conversion algorithm. In some embodiments, the system can transform existing user data into a usable structure for tracking user relationships and user activities associated with the system. In some embodiments, the system provides an application program comprising an e-commerce marketplace where users can offer items for sale and an associated system where users can promote the e-commerce marketplace or specific items or users therein.

FIG. 1 illustrates an example of a computing system 100 that may be utilized to execute various procedures, including the processes described herein. The computing system 100 comprises a standalone computer or mobile computing device, a mainframe computer system, a workstation, a network computer, a desktop computer, a laptop, or the like. The computing system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computing system 100 includes one or more processor(s) 110 coupled to a memory 120 through a system bus 180 that couples various system components, such as an input/output (I/O) devices 130, to the processor 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computing system 100 includes one or more input/output (I/O) devices 130, such as video device(s) (e.g., a camera), audio device(s), and display(s) are in operable communication with the computing system 100. In some embodiments, similar I/O devices 130 may be separate from the computing system 100 and may interact with one or more nodes of the computing system 100 through a wired or wireless connection, such as over a network interface.

Processor 110 is suitable for the execution of computer readable program instructions include both general and special purpose microprocessors and any one or more processors of any digital computing device. For example, each processor 110 may be a single processing unit or a number of processing units, and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computing system 100 includes one or more interfaces 160 that allow the computing system 100 to interact with other systems, devices, or computing environments. In some embodiments, the computing system 100 comprises a network interface 165 to communicate with a network 190. In some embodiments, the network interface 165 is configured to allow data to be exchanged between the computing system 100 and other devices attached to the network 190, such as other computer systems, or between nodes of the computing system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computing system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

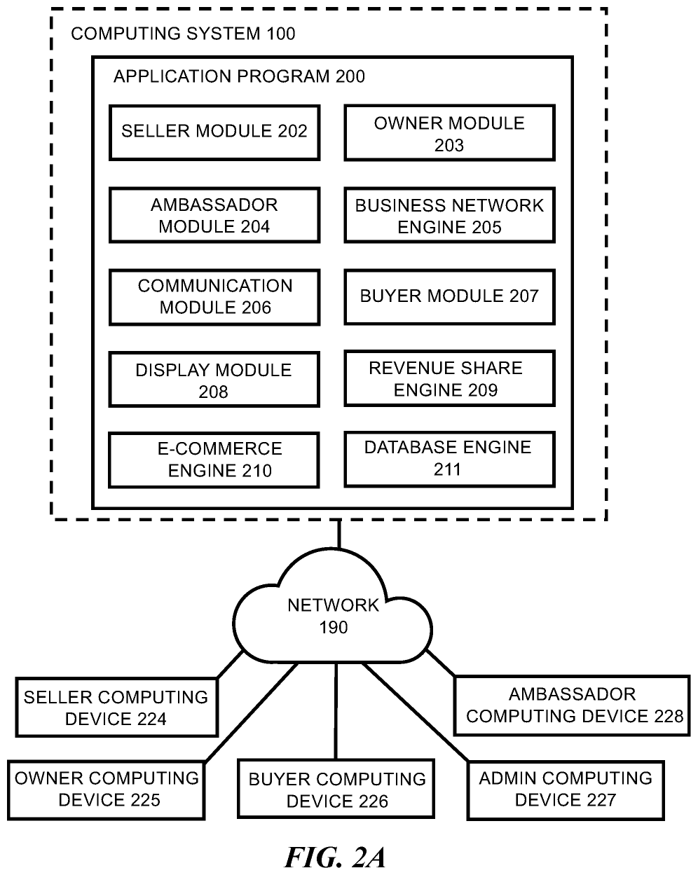

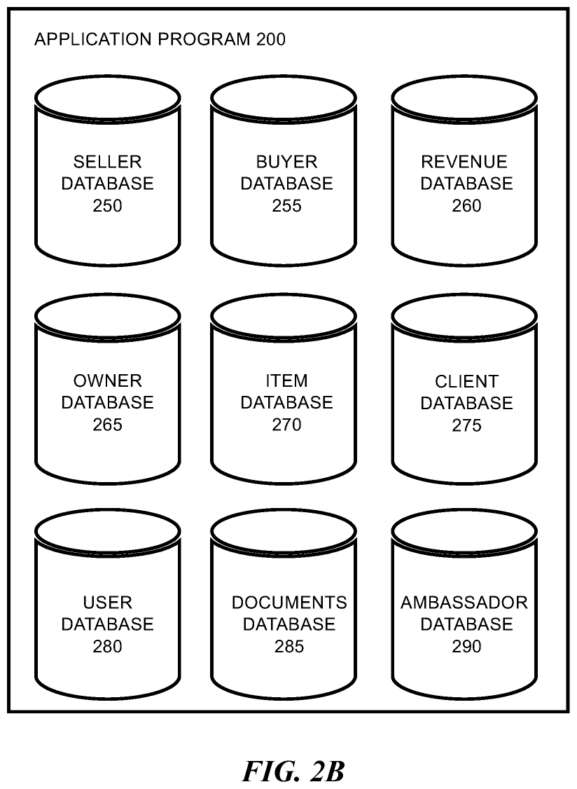

FIGS. 2A and 2B illustrate an example computer architecture for the application program 200 described herein. FIG. 2A is block diagram showing the module and engine components needed to perform the various specific tasks within the computing system 100. In particular, FIG. 2A shows the components of the application program 200, which comprises a plurality of modules and engines configured to convert an online or web-based social network into an online business network, track data across the business network, and distribute a portion of the revenue generated by the business network to the stakeholders who are responsible for creating value for the host company. FIG. 2B is a block diagram showing the one or more databases utilized by the various modules and engines in FIG. 2A.

FIG. 2A illustrates a block diagram of an application program 200, which provides an e-commerce marketplace for business network members to buy and sell items (e.g., goods, services, etc.), and a number of components for executing various algorithms for distributing a portion of the revenue generated by the marketplace or business network generally. In some embodiments, the application program 200 comprises a seller module 202, owner module 203, ambassador module 204, business network engine 205, communication module 206, buyer module 207, display module 208, revenue share engine 209, an e-commerce engine 210, and database engine 211, each of which are configured to work and communicate with one another.

As shown in FIG. 2A the application program 200 is in communication with, via the network 190, a plurality of user computing devices, including a seller computing device 224, an owner computing device 225, a buyer computing device 226, an administrator (“admin”) computing device 227, and an ambassador computing device 228.

In some embodiments, the seller module 202 is configured to facilitate the registration of new seller members, as well as the registration of new members generally. In some embodiments, the seller module 202 is configured to facilitate the registration of new users who are clients of a registered seller. For example, if a non-member agrees to have a seller list their items for sale, then the seller can create a new member account for the owner. When a client (owner) becomes a member of the network, the seller is identified as the new member's first connection. In such embodiments, the seller is facilitating the growth of their personal business network, as well as the growth of the network generally.

In some embodiments, a seller member uses the e-commerce marketplace to sell items (e.g., goods or services) they personally own or can deliver (i.e., a seller/owner). In some embodiments, the seller and owner are not the same person or member, and the seller and owner have agreed that the seller will sell an item owned by the owner. In some embodiments, the seller module 202 comprises the routines and data structures for displaying an item for sale on an e-commerce marketplace graphical user interface, and for responding to a user initiating a process for purchasing the item.

In some embodiments, the owner module 203 is configured to provide routines and data structures for monitoring one or more item(s) (e.g., goods or services) for sale on an e-commerce marketplace, as well as to provide an owner interface listing an inventory of their items for sale. In some embodiments, the owner module 203 provides the functions needed to manage the owner's relationships with one or more seller(s) handling the sale of their items. In some embodiments, the owner module 203 is configured to facilitate the process of offering an item for sale on the e-commerce marketplace without the assistance of a seller. In such embodiments, the owner module 203 comprises the routines and data structures for displaying an item for sale on an e-commerce marketplace graphical user interface, and for responding to a user initiating a process for purchasing the item.

In some embodiments, the ambassador module 204 is configured to facilitate the registration of new members. In some embodiments, the ambassador module 204 is configured to facilitate the process of promoting one or more items offered for sale on the e-commerce marketplace or promoting one or more events on the online business network. In some embodiments, the ambassador module 204 includes routines and data structures that allow an ambassador member to direct users (members or non-members) to an item displayed for sale on the e-commerce marketplace graphical user interface, and for tracking the data associated with an ambassador's effort to promote the sale of the item or the business network generally.

In some embodiments, the business network engine 205 comprises program tools that facilitate the conversion of a social network 230 configured to provide a common data graph structure to one or more business network(s) 500 having a structure that facilitates additional program tools. The various embodiments of a network conversion algorithm disclosed herein is provided by the business network engine 205.

In some embodiments, the buyer module 207 is configured to facilitate the purchase of an item listed for sale on the e-commerce marketplace. In such embodiments, the buyer module 207 comprises routines, programs, components, data structures, etc. that perform particular tasks and/or implement particular data types for completing the purchase of an item.

In some embodiments, the communications module 206 is configured for receiving, processing, and transmitting a user command and/or one or more data stream. In some embodiments, the communication module 206 allows the various system users, including a seller, buyer, owner, and/or ambassador, to communicate with one another. For example, in some embodiments, the communication module 206 performs communication functions so the owner of an item for sale can input a communication using the owner computing device 225 and the system will transmit the communication to the desired seller, who will receive and respond to the communication using a seller computing device 224. Further, a buyer may be interested in buying the item, and the buyer can input a communication using the buyer computing device 226 that will be transmitted to the seller. Further, an ambassador member can promote the sale of the item, either their own or the items of another user, using an ambassador computing device 228. In such embodiments, the system is configured to track the communications of an ambassador via, for example, an affiliate sales tracking software, in order to evaluate such a contribution.

In some embodiments, the display module 208 is configured to display one or more graphic user interfaces. In some embodiments, the display module 208 is configured to temporarily generate and display various pieces of information in response to one or more commands or operations. The various pieces of information or data generated and displayed may be transiently generated and displayed, and the displayed content in the display module 208 may be refreshed and replaced with different content upon the receipt of different commands or operations in some embodiments. In such embodiments, the various pieces of information generated and displayed in a display module 208 may not be persistently stored.

In some embodiments, the revenue share engine 209 comprises program tools that facilitate the execution of one or more revenue sharing algorithms. In some embodiments, the revenue share engine 209 manages and manipulates the data needed to determine how a portion of the revenue generated by the e-commerce marketplace or otherwise generated by the business network 500 is distributed. In some embodiments, the revenue generated by the network comprises any funds derived from, for example, transaction fees, the sale of aggregated data, the purchase of the host's software subscription, or other revenue-generating activities (e.g., fees on ticket sales for an event hosted on the network, the sale of user data). For example, a percentage of certain revenue generated by the sale of items on the e-commerce marketplace can be shared with the contributing members. As such, an ambassador member may be motivated to promote the e-commerce marketplace or a particular item for sale on the e-commerce marketplace, or to invite people to the network to grow the network, and the inviting member will also earn a percentage of all revenue generated by the new members that join based on that member's invitation. In some embodiments, one or more dynamic revenue pool(s) are created to distribute a portion of the revenue to users based on a particular, predetermined attribute (e.g., members who publish content that is viewed by at least a specific number of users). In such embodiments, the revenue share engine 209 is configured to execute one or more algorithms for determining the revenue share that will be distributed to the users having the predetermined attribute. In some embodiments, the revenue share engine 209 is configured to automatically determine the revenue share to be distributed to one or more ambassador members. In such embodiments, the conversion of the social network 300 to the business network 500 facilitates the use of the revenue share engine 209 to equitably distribute a portion of the revenue generated to a predetermined number of members based on the value of their contributions to the network.

In some embodiments, the e-commerce engine 210 comprises program tools that facilitate the execution of particular tasks and/or implement particular data types for offering an item for sale and for completing the purchase of the item. In some embodiments, the e-commerce engine 210 is configured to execute one or more inputs from a buyer, seller, and/or owner, and transmit the one or more inputs to one or more user interfaces through the display module 208. In some embodiments, the e-commerce engine 210 is configured to automatically allocate the proceeds of a sale to the contributing owners and sellers. An owner can sell their own items on the e-commerce marketplace or arrange to have a seller sell their items. If an owner and seller have an agreement in place for their business arrangement, the agreement document is saved in the appropriate databases of the application program 200 and communicated to the e-commerce engine 210 for processing the allocation of proceeds received from a sale.

In some embodiments, a database engine 211 is configured to facilitate the storage, management, and retrieval of data to and from one or more storage mediums, such as the one or more internal databases 250, 255, 260, 265, 270, 275, 280, 285, and 290. In some embodiments, the database engine 211 is coupled to an external storage system. In some embodiments, the database engine 211 is configured to apply changes to one or more databases. In some embodiments, the database engine 211 comprises a search engine component for searching through thousands of data sources stored in different locations.

As shown in FIG. 2B, a plurality of databases is included in the application program 200 and each database is in communication with the various components in the application program 200 via the database engine 211. In some embodiments, for example, the program comprises a seller database 250, a buyer database 255, a revenue database 260, an owner database 265, an item database 270, a client database 275, a user (e.g., member, non-member) database 280, a documents database 285, and an ambassador database 290. The databases may be implemented as one or more types of databases, including, for example, a hierarchical database, a relational database, an object-oriented database, one or more flat files, or any combination thereof.

In some embodiments, any information associated with communications involving the seller is retrievably stored in the seller database 250; any information associated with communications involving the owner is retrievably stored in the owner database 265; any information associated with communications involving the client is retrievably stored in the client database 275; any information associated with communications involving the item for sale is retrievably stored in the item database 270; and any information associated with communications involving the ambassador is retrievably stored in the ambassador database 290.

In some embodiments, the seller database 250 retrievably stores the data associated with a seller member. In some embodiments, the seller serves as an agent to sell items owned by another. In such embodiments, the information associated with the owner-seller relationship, including information associated with the sale of an item, is retrievably stored in the seller database 250. For example, the information may include the member selling the item, the item offered for sale, the price of the item, and/or any other relevant information for tracking the interactions of a seller with a buyer. In some embodiments, the relevant information may include how a seller was drawn to the e-commerce marketplace and/or who the seller's first connection was upon joining the application program 200.

In some embodiments, the buyer database 255 stores any data associated with a buyer member who has completed a transaction in the application program 200. Such data relates to information including the member buying the item, the item offered for sale, the price of the item, and/or any other relevant information for tracking the interactions of a buyer. In some embodiments, the relevant information may include how a buyer was drawn to the e-commerce marketplace. For example, if an ambassador member uses an affiliate link to promote another member's item for sale on the e-commerce marketplace, and the affiliate link leads to the sale of the item to a non-member (before the sale), then the data associated with the affiliate link is tracked such that the ambassador member who sent the affiliate link is credited as the new member's first connection.

In some embodiments, the revenue database 260 stores data associated with the sale of an item, including the sales price agreed upon for the item, the service fees associated with a sale on the application program 200, and a ledger for recording each sale. In some embodiments, for any revenue-generating transaction occurring through the application program 200, the system will attach a service fee for any transaction conducted through the seller module 202. In such embodiments, this information will be stored in the revenue database 260, where it can be retrieved by the revenue share engine 209 or the e-commerce engine 210.

In some embodiments, the owner database 275 retrievably stores the data associated with a member who wants to sell an item on the e-commerce marketplace. In some embodiments, the owner sells their own items. In some embodiments, the owner agrees to have a seller member serve as an agent to sell items owned the owner member. In such embodiments, the information associated with the owner, the owner's items, and the owner-seller relationship is retrievably stored in the owner database 275.

In some embodiments, the item database 270 retrievably stores the data associated with any items offered for sale on the e-commerce marketplace. Such data relates to information including the item offered for sale, the price of the item, the owner and/or seller associated with the item, the length of time the item was for sale, how many members viewed the item for sale, and/or any other relevant information for tracking the sale of an item.

In some embodiments, the client database 275 retrievably stores the data associated with third party users or entities who want to work with the host company of the business network. For example, third party users or entities may engage the host company to use the business network, including the e-commerce marketplace, for various activities (e.g., hosting an event or art gallery on the network) or for other business reasons (e.g., the sale of user data, licensing the network). In some embodiments, the information associated with the client, including information associated with a business agreement with the client, is retrievably stored in the client database 275. In some embodiments, a client member licenses the network to host an event on the system. In such embodiments, the host client member will be identified as the first connection for any new member resulting (e.g., directly) from the event.

In such embodiments, the user database 280 stores the data associated with a member of the system, including e-mail address, personal websites, social networking profiles, contact/rolodex information, and/or any other relevant information for tracking the promotion efforts of the member.

In some embodiments, the documents database 285 retrievably stores any agreements between the host system or any sellers, buyers, ambassadors, and/or clients. In some embodiments, when a seller offers to sell items owned by another seller and an agreement is reached, the owner becomes the seller's client and any agreements between the parties is stored in the documents database 285. For example, if the parties agree that the seller will receive a percentage (%) of the funds generated from the sale of one or more items, then such an agreement will be stored in the documents database 285. The communications module 206 will facilitate communication between the parties (e.g., negotiate terms, executing agreements, and other communications). The agreement allows the application program 200 to automatically reward the owner and the seller appropriately when the item is sold. In such embodiments, the e-commerce engine 210 executes an input from a buyer, seller, and/or owner and transmits the input to one or more user interfaces through the display module 208.

In such embodiments, the ambassador database 290 stores the data associated with a member's efforts to promote the sale of a particular item or more generally the application program 200. Such data relates to information including e-mails, text messages, QR codes, or any other means for sending a member or non-member an electronic link to access a particular item to sell or the application program 200.

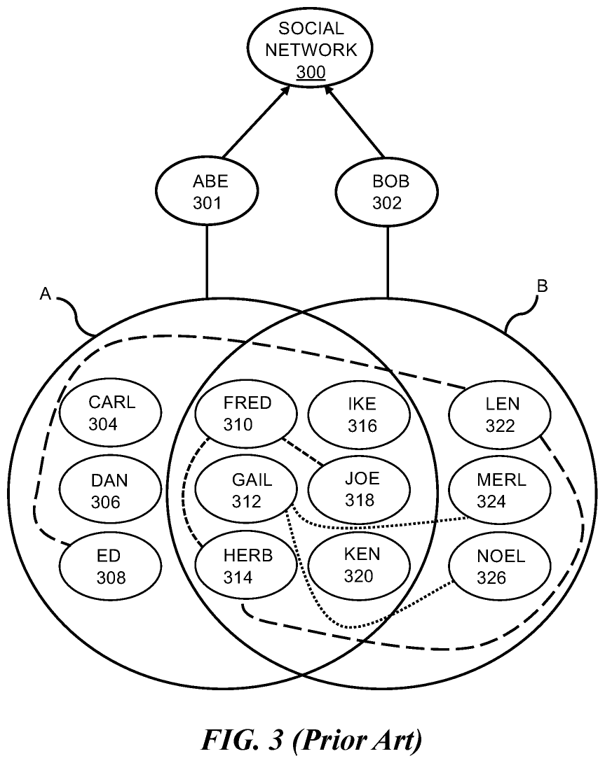

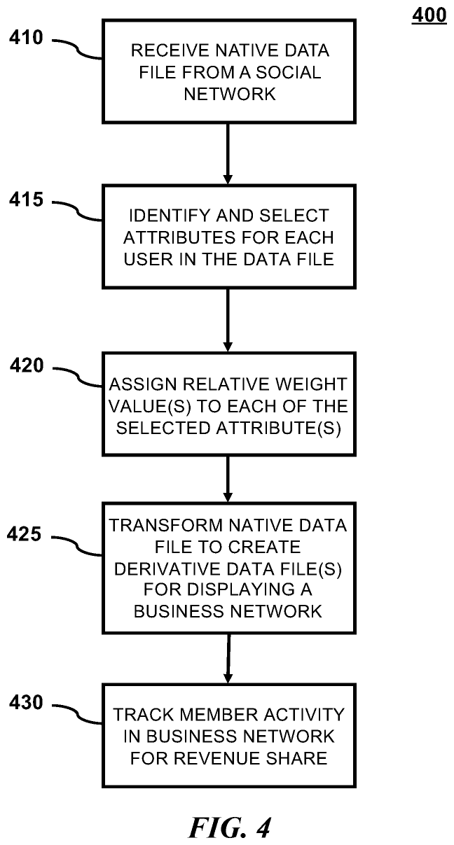

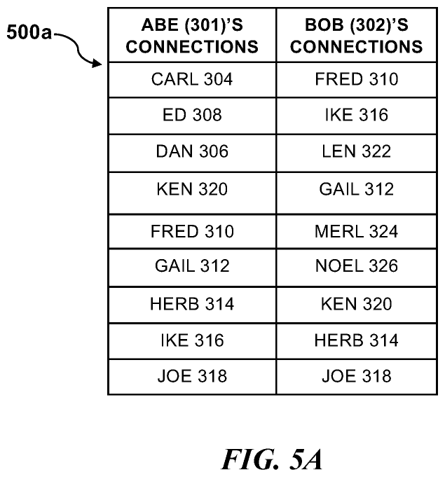

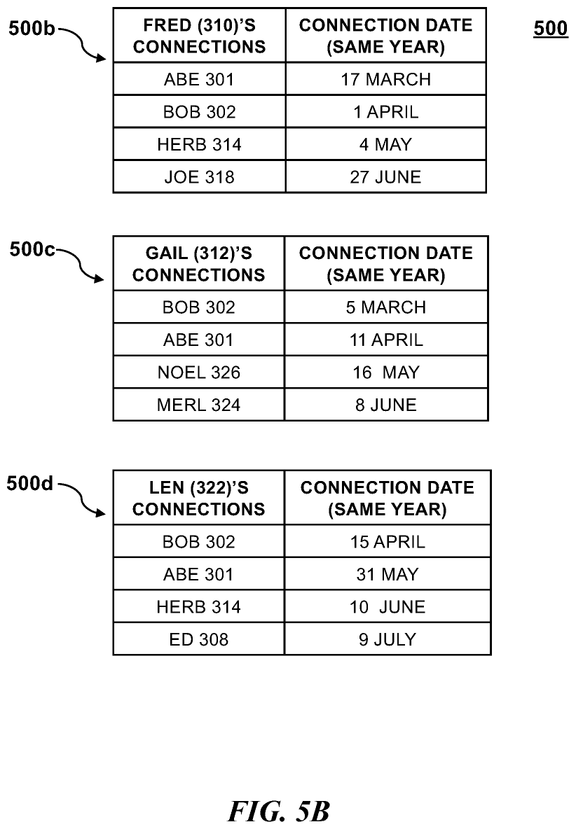

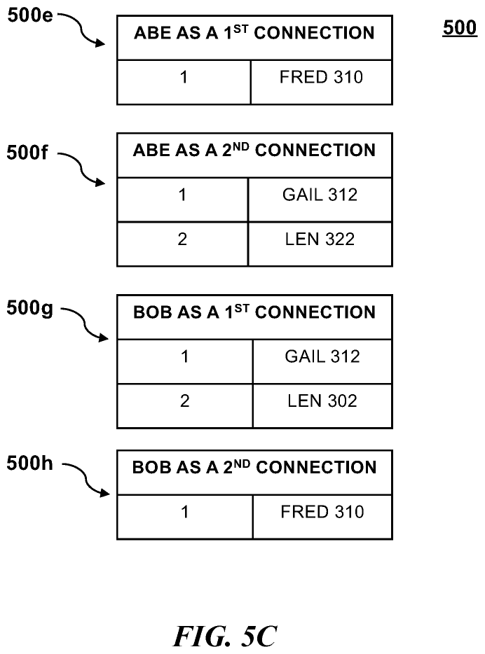

FIGS. 3-5C illustrate the transformation of a social network into a business network. Specifically, FIG. 3 shows a common data structure for a prior art social network 300 as it is organized prior to the transformation, FIG. 4 shows the network conversion algorithm 400 for carrying out the transformation, and FIGS. 5A-5C show certain various business networks 500a-h resulting from the transformation.

FIG. 3 shows a social graph of the data in a typical online social network 300 in which each vertex (node) represents a member (by name) and each edge (line) represents a member-to-member connection. For simplicity, FIG. 3 shows the connections for only Abe 301, Bob 302, Fred 310, Gail 312, and Len 322; and each member grouped in the ovals A, B is connected to Abe 301 and Bob 302, respectively. The native data file is configured to display as a graph each member and their circle of connections in the social network 300. The social graph structure for display is organized without regard to the attribute assigned to the temporal information associated with the member-to-member connections in the native data file of members, or any attribute assigned to the value each member contributes to the social network. In the example in FIG. 3, members Carl 304, Dan 306, Ed 308, Fred 310, Gail 312, Herb 314, Ike 316, Joe 318, and Ken 320 are each connected to Abe 301; and Fred 310, Gail 312, Herb 314, Ike 316, Joe 318, Ken 320, Len 322, Merl 324, and Noel 326 are each connected to Bob 302. In FIG. 3, the primary attributes in the social network 300 are the member name and the member-to-member connections. Indeed, those are the only attributes required to display a member's individual network. Based on those attributes, the online social network is configured to display information illustrating that each of Abe 301 and Bob 302 is connected with nine other members, and Abe 301 and Bob 302 share connections with six other members.

In FIG. 3, the arrows directed from Abe 301 and Bob 302 toward the social network 300 indicate that the network is structured according to a shareholder model, meaning that essentially any benefit associated with Abe's 301 and Bob's 302 efforts to grow their individual networks flow to the social network 300. In this context, the term “benefits” relates to any revenue-generating product or service that can be traced back to the efforts and/or growth of Abe's 301 or Bob's 302 network (e.g., clicks on an advertisement). As such, the host company for the online social network would receive all benefits, including any revenue generated from the program.

In order to transform a typical online social network 300 into an online business network 500, according to some embodiments disclosed herein, the network conversion algorithm 400 is utilized to create one or more new, derivative data files based on the native data file received from the social network 300. In some embodiments, the derivative data files are configured to display information in one or more derivative structures based on member attributes other than the member name and the member-to-member connections.

In some embodiments, the network conversion algorithm 400 comprises one or more steps. As shown in FIG. 4, step 410 includes receiving the data associated with the online social network 300 (e.g., native data file listing members and connections for each member). In some embodiments, the receiving step 410 comprises obtaining (e.g., downloading, transmitting, syncing, etc.) a native data file of members that is adapted and configured to display a social graph structure on a graphical user interface.

In step 415, the system identifies one or more attributes for each member in the native data file. In some embodiments, the attributes include the member name, member-to-member connections, and temporal information associated with the member-to-member connections. In some embodiments, additional attributes are considered, including, for example, the member's age, sex, location, education, email address, telephone number, employer, skills, interests, etc. In some embodiments, further attributes are considered, including the various ways each member engages with others on the network, such as the content they contribute and the influence the content has on others (e.g., views, shares). In step 415, the system selects the attributes required for a predetermined purpose. For example, if the administrator wants to create a business network structure showing each member who has a connection to a specific member, then the member name and member-to-member connections will be selected as the predetermined attributes for display.

In FIG. 4, step 420, a weight value is assigned to each of the attributes in the native data file to represent a relative mathematical importance and/or to emphasize one or more particular attributes. Based on the predetermined attribute(s) that are selected, a derivative data file and/or derivative structure for a business network 500 can be created in step 425 that features the predetermined attribute(s).

In some embodiments, the second and/or subsequent connection(s) made by each member is identified. In some embodiments, the first and second connections made by each member are identified. In some embodiments, the 2^{nd}, 3^{rd} . . . n^{th} connections made by each member are identified. Generally, identifying more connections for each member provides a more robust assessment of the value a particular member has brought to the network. In some embodiments, the 1^{st}, 2^{nd}, 3^{rd} . . . n^{th} connections can be identified using one or more tools, including affiliate link tracking, direct invitations via system invite software, client creation via a professional seller software, buyer account creation to purchase an item from the marketplace, and account creation to follow site content managers (e.g., videos, blogs, groups, events, etc.).

In some embodiments, the date and time a member joins the network is used to determine the status of a user as a first connection (e.g., when two members “connect as friends” but are not connected to an existing social network). In some embodiments, a member on the network has no first connection. In that case, the member is categorized as an “orphan” member, and the member is temporarily assigned to the system administrator as their first connection. In such embodiments, when an orphan member makes an organic first connection to another member on the network, then that member becomes the orphan member's first connection, and the host company and/or system administrator will no longer be the first connection for that user.

In step 425, one or more derivative data file(s) and/or derivative structure(s) is created for displaying a business network 500. In such embodiments, the derivative data file is configured to display the one or more derivative structure(s) in a manner that is useful for the business network 500. In this context, the term “useful” relates to the ability of a system user to track and/or reward the activities of the most influential members. In some embodiments, for example, the one or more derivative data file(s) is adapted and configured to display the one or more derivative structure(s) as a table.

In step 430, in some embodiments, member activity in the business network 500 is tracked. In some embodiments, for example, a member's influence can be tracked in step 430 by the number of connections established and/or the value those connections provide the network. In such embodiments, a stakeholder model having a revenue share flowing to the members of the business network 500 can be created.

FIGS. 5A-5C illustrate some embodiments of the transformation of social network 300 to business network 500 via the network conversion algorithm for each of Abe 301 and Bob 302. Referring to FIG. 5A, table 500a represents an example structure of the initial data received from the social network 300 in step 410. In table 500a, however, the overlapping connections between the members of Abe's and Bob's social network are not disclosed (e.g., Fred 310 and Ike 316 are both connected to both Abe 301 and Bob 302). Table 500a shows each member that has been connected to Abe 301 and/or Bob 302. Specifically, Abe's connections include: Carl 304; Ed 308; Dan 306; Ken 320; Fred 310; Gail 312; Herb 314; Ike 316; Joe 318; and Bob's connections include: Fred 310; Ike 316; Len 322; Gail 312; Merl 324; Noel 326; Ken 320; Herb 314; Joe 318.

In some embodiments, step 415 of the network conversion algorithm requires the identification of attributes for each member, and in step 420, a weight is assigned for specific attributes in order to produce derivative data sets that display a business network. Referring to FIG. 5B, tables 500b, 500c, and 500d show the first four connections for members Fred 310, Gail 312, and Len 322, respectively, and the dates of their connection. In such embodiments, the system identifies the connections that each member makes from the point in time of when they join the network. According, the attributes are weighted to display a derivative data set including the member name, member-to-member connections, and the connection date for only four connections. Table 500b shows that after Fred 310 joined the network 500, his first connection was Abe 301, his second connection was Bob 302, his third connection was Herb 314, and his fourth connection was Joe 318. Table 500c shows that after Gail 312 joined the network 500, her first connection was Bob 302, her second connection was Abe 301, her third connection was Noel 326, and her fourth connection was Merl 324. Table 500d shows that after Len 322 joined the network, his first connection was Bob 302, his second connection was Abe 301, his third connection was Herb 314, and his fourth connection was Ed 308.

Although this example illustrates the first four connections of the members, the number of enumerated connections can be any predetermined number (e.g., 2, 3, 4, 5, 6, 7, 8 . . . n). Any particular number of connections will be a predetermined weighted attribute such that only the most relevant data is displayed. In some embodiments, limiting the number of connections may result in bigger rewards for each user, and therefore provide greater incentive to contribute to the business network than if the reward was less significant.

In this example, the conversion of the social network 300 into the business networks shown in tables 500b, 500c, and 500d provides a static value for the tracking and rewarding of users for purposes of revenue share. As used herein, the term “static” refers to a value that does not change. In other words, Abe 301 will always be Fred 310's first connection, and Bob 302 will always be Gail 312's and Len 322's first connection. Referring to FIG. 5C, the tables 500e, 500f, 500g, and 500h provide a list of each member who connected with Abe 301 first, with Abe 301 second, with Bob 302 first, and with Bob 302 second, respectively.

In some embodiments, when an item is sold on the e-commerce marketplace, the seller and/or owner will receive the proceeds from the sale, except for any portion deducted as a transaction fee and/or other service fee by the host company. In some embodiments, the member who is identified as the seller's or owner's first connection, or second or otherwise later connection, is identified as well. This is because the seller or owner was likely invited to the network by their first or second connection, which can be verified. Accordingly, while the sale of an item is a valuable contribution from that seller or owner to the network, the person who invited that seller or owner has also provided a valuable contribution to the network by inviting them as a new member. In some embodiments, when a seller or owner sells an item, the member who was that seller or owner's first, second, etc. (predetermined) may also become eligible to receive a share of the revenue (e.g., transaction fees) received by e-commerce marketplace and/or business network generally. For example, a portion of the revenue share may be divided among those members identified as a first connection, second connection, etc., to members that have generated revenue on the e-commerce marketplace. In such embodiments, the share allocated to the first, second, etc. members may be weighted based on the connection status. For example, if three connections are considered for the revenue share, the first, second, and third connections may be weighed with a distribution ratio of, for example, 85/10/5. In this example, when $1 of revenue share is distributed to the member base: 85% is distributed to the first connection; 10% is distributed to the second connection, and 5% is distributed to the third connection. Other distribution ratios are contemplated (e.g., 80/15/5; 90/5/5; 75/15/10; etc.).

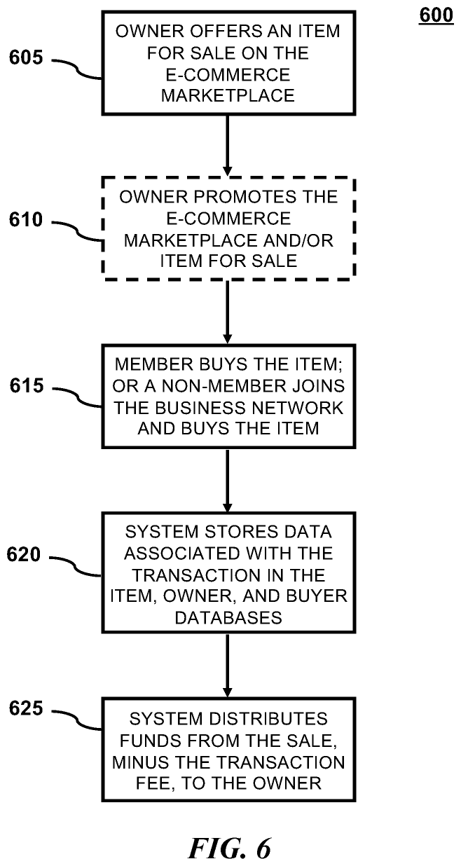

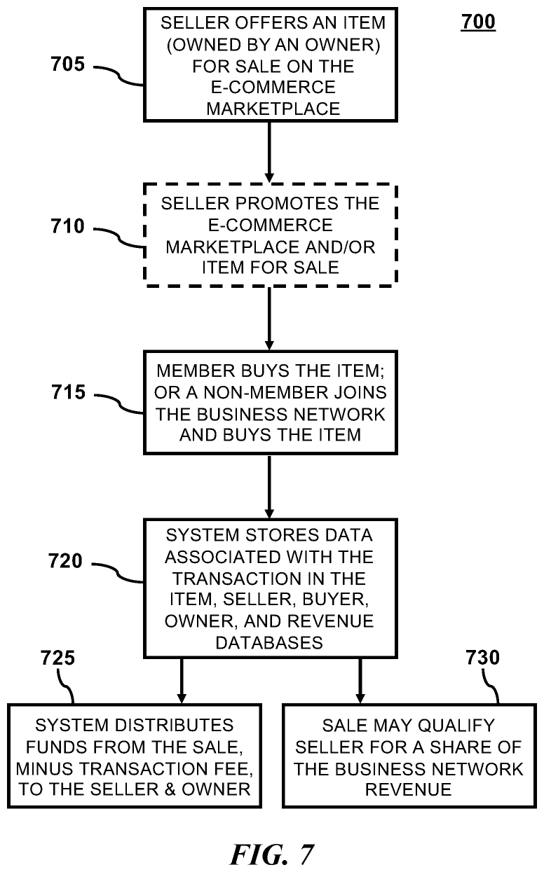

FIG. 6 and FIG. 7 show the processes 600 and 700, respectively, associated with the sale of an item on the e-commerce marketplace. In process 600, step 605, an owner operating as their own seller offers an item for sale as a personal listing on the e-commerce marketplace. In step 610, the owner optionally promotes a particular item for sale and/or promotes the e-commerce marketplace itself. Such promotions may target members of the business network and/or non-members. For example, a member can email an invitation to join the e-commerce marketplace to a non-member and/or an invitation to view a particular item for sale on the e-commerce marketplace. In some embodiments, the invitation is sent via an affiliate link, which can indicate to the system track whether that particular invitation led to a sale. If the member who sent an affiliate link is not the seller, then the system would connect that member to the buyer as their first connection. However, even if a member was not formerly invited to the business network, they may create an account to purchase the item offered for sale by the owner, and that owner would be considered the new member's first connection (assuming they have not yet become connected with someone else).

In step 615, a member buys the item, or a non-member accepts an invitation to join the business network and e-commerce marketplace and then buys the particular item for sale. In some embodiments, a non-member does not need to create an account to view a particular item for sale on the e-commerce marketplace. But in some embodiments, the non-member will need to create an account if they want to purchase the item. In other embodiments, the non-member will not need to create an account to purchase the item. In such embodiments, the buyer does not become connected to the owner (selling their own item).

In step 620, the e-commerce engine 210 and the database engine 211 will facilitate the storage of the data associated with the offer, electronic invitation, and/or the sale of the item (transaction) to an appropriate database(s) (e.g., the item, owner, and buyer databases). In some embodiments, the storage of data can occur at any time in the process and the storage step may be repeated any number of times throughout the process to store the data in a database. In step 625, the system distributes the funds received from the transaction, minus the fee owed to the host company, to the owner.

In process 700, step 705, a seller offers an item for sale on the e-commerce marketplace. In this context, a “seller” means the user is registered as a seller on the application program 200. A seller may or may not own an item offered for sale. If the seller is also the owner of the item, then the process 600 applies. In some embodiments, the seller does not own an item for sale, and the process 700 applies because the seller has agreed to offer the item for sale via a managed listing for the owner according to terms that they determine (e.g., consignment). In such embodiments, in step 710, the seller optionally promotes the particular item for sale and/or the e-commerce marketplace itself. Such promotion may target members or non-members of the business network. For example, a member can email an invitation to join the e-commerce marketplace to a non-member and/or to view the particular item for sale on the e-commerce marketplace. In some embodiments, the invitation is sent via an affiliate link, which can indicate to the system to track whether that particular invitation led to a sale. However, even if a member was not formerly invited, they may create an account on the business network to purchase the item offered for sale by the seller, and that seller would be considered the new member's first connection (assuming they have not yet become connected with someone else).

In step 715, a member buys the item, or a non-member accepts an invitation to join the business network and views the e-commerce marketplace and then buys the particular item for sale. In some embodiments, a non-member does not need to create an account to view a particular item for sale on the e-commerce marketplace. But in some embodiments, the non-member will need to create an account if they want to purchase the item. In other embodiments, the non-member will not need to create an account to purchase the item. In such embodiments, the buyer does not become a connection to the seller.

In step 720, the e-commerce engine 210, the revenue share engine 209, and the database engine 211 will facilitate the storage of the data associated with the offer and the promotion of the item to an appropriate database (e.g., the item, seller, buyer, owner, and revenue databases). In some embodiments, the storage of data can occur at any time in the process and the storage step be repeated any number of times throughout the process to secure the data in a database. In step 725, the system distributes the proceeds received from the transaction, minus one or more fee(s) owed to the host company, to the seller and owner, respectively. In step 730, the sale of the item may, depending on the revenue allocation algorithm, qualify the seller or the member who invited the seller to the network to a share of the business network revenue.

In some embodiments, a social network restructured as a rigid hierarchy business network creates a static structure that facilitates tracking and rewarding active users for revenue generated from within their individual networks. In some embodiments, because the hierarchy is a rigid structure, at least a portion of the associated benefits resulting therefrom generally does not fluctuate (except when the number of active members in an individual network increases or decreases, but that is measurable). In some embodiments, the distribution ratio for the revenue share remains the same, but the revenue share increases or decreases. In some embodiments, the distribution ratio of the revenue share remains the same, but the rewards are distributed to different members. For example, in one month the highest three ranked users (A, B, C) may be rewarded a portion of the revenue share in an 85/10/5 ratio (A gets 85%; B gets 10%; C gets 5%); however, in a different month the rankings have changed such that the highest three ranked users (B, D, A) are rewarded according to the distribution ratio (B gets 85%; D gets 10%; A gets 5%). Rankings, in this context, are based on a user's contribution to the revenue share for the business network 500. In such embodiments, the ranking is based on contribution rather than the number of connections a user has.

The value a member creates for the business network is not only based on the revenue generated from sales on the e-commerce marketplace. In some embodiments, a member contributes to the business network in other ways, including, for example, posting content (e.g., articles, videos, etc.) that is considered interesting or valuable to other members. One of the advantages to the structure of the business network 500 obtained from the network conversion algorithm 400 is the ability to track member activity in step 430. By structuring a rigid hierarchy out of a social network, a member's influence can be tracked and measured, and the members can be individually rewarded for contributing to the business network 500. The various contributions a member provides may change from month to month. Accordingly, in some embodiments, the system assigns a dynamic value to each member. For example, in one embodiment, Abe 301 invites Fred 310 to the online network. When Fred 310 becomes a member of the network, Abe 301 is identified as his first connection. In some embodiments, by introducing Fred 310 to the network, Abe 301 will be rewarded for any benefits the network receives as a result of Fred's 310 activities on the network. For example, if Fred 310 contributes content to the network in the form of a blog, and other members who read articles or other content on the blog become increasingly involved in the network, they may forward the blog to non-members and/or invite non-members to become members of the network. In this scenario, Fred 310 is adding value to the network, and the system will track the other members following the blog in order to attribute the value they contribute to the network.

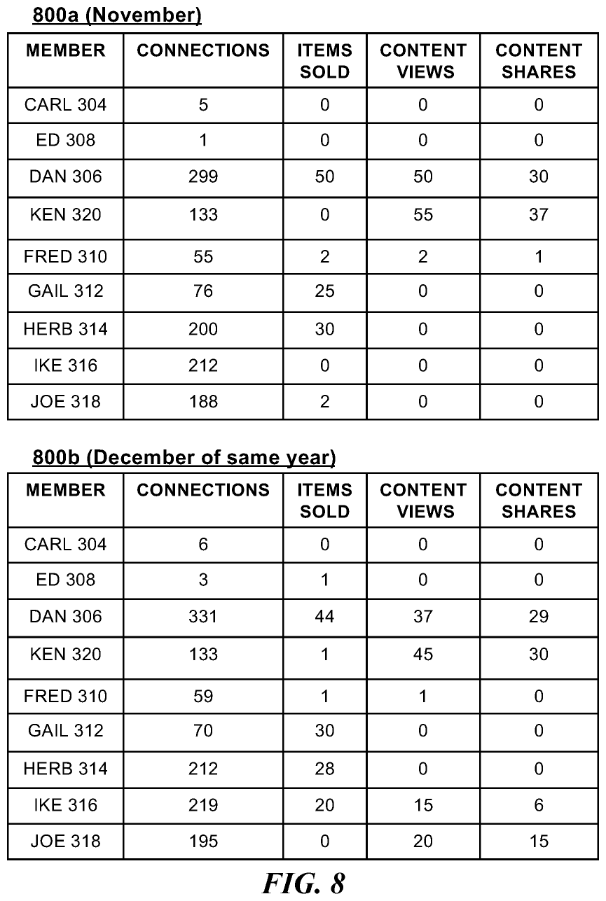

Referring to FIG. 8, table 800a shows certain data obtained from tracking the activities of several members in the month of November. In this example, the system identifies not only the items sold by each member, but also the content posted, in terms of the number of views and shares by other members. Table 800b shows a similar table but is directed to the data traced in December of the same year. Some members are able to sell a large number of items in a consistent manner (e.g., Dan 306 sold 50 items in November and 44 items in December; Gail 312 and Herb 314 also provided consistent sales). The sales by some members fluctuate from month to month (e.g., Ike 316 sold zero items in November and 20 items in December). Further, the content posted by members can fluctuate from month to month. For example, although Dan 306 and Ken 320 were able to submit content that was viewed a similar number of times in November and December, Ike 316 and Joe 318 contributed far more content in December than in November. Indeed, Joe 318 has his content shared 15 times in December and did not post any content in November. In some embodiments, a portion of the revenue share, the dynamic value, can be allocated to a certain predetermined number of members based on a measurable value contributed by that member over a predetermined period of time (e.g., day, week, month, quarter, year, etc.).

In some embodiments, the system includes a plurality of “dynamic revenue pools” (e.g., 2, 3, 4, 5, 6, etc.). In such embodiments, members can be rewarded a portion of the revenue share based on the performance metrics of the overall host network system. In some embodiments, the reward is based on a dynamic network structure, in which members are rewarded based on secondary network attributes, including, for example, the number of views a posted video receives, the amount of engagement with a member's content, the number of shares a member's blog post gets, etc. In one such example, if a first member receives 100 views for a video they posted and a second member receives 50 views for a video they posted, then the first member will get a larger share of a dynamic revenue pool for video pools (or content views) than the second member because their video received twice as many views.

In some embodiments, the dynamic network structure is used to reward, for example, the growth of a member's network, the growth of a member's blog following, the growth of a member's video views, and the improvement in a member's engagement. In such embodiments, a member can be rewarded periodically for their performance, and it serves as a further way to weigh the value of their contribution to the network. In some embodiments, the member must be registered as an ambassador to be rewarded for their contributions.

These types of metrics may fluctuate often, which means a member's portion of the revenue share would also fluctuate. For example, if member engagement is a secondary network attribute that is selected for a particular reward, then a percentage (e.g., 1%) of the total revenue share will be allocated to a “member engagement pool.” In this context, the “pool” is a fixed amount of revenue that is split into shares, and users showing an increase in user engagement would be compensated by earning shares in the pool. In such embodiments, the shares earned in the pool may fluctuate between periods (e.g., week-to-week; month-to-month) because user engagement may fluctuate. Thus, a member's share in this pool would also fluctuate. By rewarding members for their content based on the action of other members, the most valuable contributors of content can be identified and rewarded accordingly.

In some embodiments, the dynamic form of compensation allows a member to be rewarded for value attributed to their static network and from the entire network. In such embodiments, the business network allows a member to be rewarded based on the host company's revenue and the member's individual sales. The value of a member's contribution is not arbitrary. In some embodiments, the value of a member's contribution is based on the number of connections a member has, or the number of connections that are active users of the system. In some embodiments, the value is based on the revenue flowing through a member's activities. The system allows user-defined parameters to track and reward members (stakeholders) for any type of content they create or contribute to the network. In such embodiments, the system allows an assignment of a specific value to specific content in order to equitably reward each member (stakeholder). While some example relates to content contributed through a blog, the contribution can include other parameters, such as video creation, the administration of a group, etc.

The business network 500 provided by the methods described herein has several advantages compared to existing social networks. In some embodiments, the contributions of each member, including those based on a static value and those based on a dynamic value, are measurable and tracked in order to compensate the stakeholders (i.e., members) who have increased the growth and revenue generated by the system. The revenue distribution algorithm and automated methods described herein for distributing proceeds to owners and sellers and for distributing revenue share to other members (e.g., ambassador members) create a practical benefit for the owner, ambassador, and seller members, in that their relationship to one another may be established locally (geographically) and certain revenue received will be directed back to them and their local community. In such a scenario, the business network 500 provides opportunity for people living in depressed localities to work together to stimulate their local economy. Furthermore, the business network 500 distributes a portion of the host company revenue to the members, which provides a benefit to the individuals, rather than channeling all proceeds and/or value from members of a typical social network to the host company and accumulating those proceeds and/or value in a centralized manner.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/We claim:

1. A computer program product embodied on a non-transitory computer readable medium, the computer program comprising computer code adapted to be executed by a computer to perform a method comprising:
receiving a native data file comprising a list of members of an online social network, the native data file being adapted and configured to display a social graph structure of the members, wherein the native data file comprises attributes assigned to a member name, a member-to-member connection, and temporal information associated with the member-to-member connection, and the social graph structure is based on the attributes assigned to the member name and the member-to-member connection;
assigning a weight value to each of the attributes in the native data file to represent a relative mathematical importance and to emphasize one or more predetermined attributes;
transforming the native data file into a first derivative data file that is adapted and configured to display a first derivative structure of the members based on the weight values assigned to each of the attributes in the native data file, including the member name, the member-to-member connection, and the temporal information associated with the member-to-member connection; and
displaying as a first business network the first derivative structure for each member of the native data file based on the weight value assigned to the temporal information associated with the member-to-member connection.

2. The computer program product of claim 1, wherein the weight value assigned to the temporal information associated with the member-to-member connection is superior in relative mathematical importance to the weight value assigned to the member name and the member-to-member connection in the first derivative structure of the members for display.

3. The computer program product of claim 1, wherein the social graph structure for display is organized without regard to the attribute assigned to the temporal information associated with the member-to-member connection in the native data file of members.

4. The computer program product of claim 1, wherein the method further comprises:
creating a second derivative structure of the members for display based on the weight values assigned to the attributes in the native data file, including the member name, the member-to-member connection, and the temporal information associated with the member-to-member connection; and
displaying as a second business network the second derivative structure for each member of the native data file of members based on the weight value assigned to the member-to-member connection.

5. The computer program product of claim 4, wherein the method further comprises:
creating a third derivative structure of the members for display based on the weight values assigned to the attributes in the native data file, including the member name, the member-to-member connection, and the temporal information associated with the member-to-member connection; and
displaying as a third business network the third derivative structure for a specific member of the native data file of members based on the weight value assigned to the member-to-member connection with respect to the specific member.

6. The computer program product of claim 1, wherein the method further comprises:
tracking one or more activities for a member in the first business network;
determining a first contribution value for the member based on the one or more activities; and
rewarding a predetermined number of members in the first business network based on their first contribution value.

7. The computer program product of claim 4, wherein the method further comprises:
tracking one or more activities for a member in the second business network;
determining a second contribution value for the member based on the one or more activities; and
a predetermined number of members in the second business network based on their second contribution value.

8. The computer program product of claim 5, wherein the method further comprises:
tracking one or more activities for a member in the third business network;
determining a third contribution value for the member based on the one or more activities; and
a predetermined number of members in the third business network based on their third contribution value.

9. The computer program product of claim 6, wherein the rewarding step comprises:
determining a first contribution value for each member relative to other members in the first business network;
determine a second contribution value for each member connected to the member relative to other members in the first business network; and
determine a third contribution value for each member relative to other members in the first business network;
wherein the first contribution value is based on the tracked activities of the member, the second contribution value is based on the tracked activities of a predetermined number of the member's connections, and the third contribution value based on the tracked activities of the member, and
wherein the third contribution value is weighed more than the first contribution value or the second contribution value as indicators of the user's total contribution to the first business network.

10. The computer program product of claim 6, wherein the one or more activities comprises: selling an item on an e-commerce marketplace associated with the first business network; promoting the first business network; promoting an item for sale on the e-commerce marketplace; or creating content for the first business network.

11. A computer implemented method, comprising:
providing an online social network system;
receiving revenue to be distributed among one or more users of the online social network system;
collecting data associated with the revenue received;
determining which users of the one or more users are associated with the revenue received;
determining a plurality of attributes for each of the one or more users;
wherein, for each particular attribute of the plurality of attributes, calculating a metric value for each of the one or more users who have the particular user attribute, based on the collected data;
determining a plurality of revenue distribution rules based on the calculated metric value for the one or more users having the user attribute;
storing the determined plurality of revenue distribution rules;
generating a revenue distribution schedule by examining the stored plurality of revenue distribution rules; and
distributing the revenue received to the one or more users according to the revenue distribution schedule.

12. The computer implemented method of claim 11, wherein the metric value is the sale of an item on an e-commerce marketplace within the online social network system; promoting the item for sale on the e-commerce marketplace; promoting the e-commerce marketplace; licensing the e-commerce marketplace; or creating content on the social network system.

13. The computer implemented method of claim 11, wherein the plurality of attributes for the one or more users comprises username, user-to-user connections, and temporal information associated with the user-to-user connections.

14. The computer implemented method of claim 11, wherein the plurality of attributes for the one or more selected users comprises user age, user sex, user location, user education, user email address, or user telephone number.

15. The computer implemented method of claim 11, further comprising:
determining at least one revenue distribution rule by applying the activity data of the one or more users associated with the revenue received to a particular user attribute;
storing the determined at least one distribution rule of distributing revenue; and
generating a further revenue distribution schedule by examining the stored determined at least one distribution rule of distributing revenue.

16. The computer implemented method of claim 11, wherein the plurality of revenue distribution rules comprises at least one of the following:
if the metric value is a sale of an item on an e-commerce marketplace within the online social network system, then the revenue received is distributed to users having a user attribute based on username, user-to-user connections, and temporal information associated with the user-to-user connections;
if the metric value is promoting the item for sale on the e-commerce marketplace within the social network system, then the revenue received is distributed to users having a user attribute based on username, user-to-user connections, and temporal information associated with the user-to-user connections;
if the metric value is promoting the e-commerce marketplace, then revenue received is distributed to users having a user attribute based on username;
if the metric value is licensing the e-commerce marketplace, then revenue received is distributed to users having a user attribute based on username; or
if the metric value is creating content on the social networking system, then revenue received is distributed to users having a user attribute based on username, user-to-user connections, and temporal information associated with the user-to-user connections.

17. The computer implemented method of claim 16, wherein the user-to-user connections and temporal information associated with the user-to-user connections are each limited to a predetermined number of connections.

18. The computer implemented method of claim 17, wherein the predetermined number of connections ranges from a first connection to a tenth connection.

19. A system for tracking user data across an online business network, comprising:
at least one computing device in operable communication with a network;
a memory that stores computer-executable instructions;
a processor in communication with the memory and configured to execute the computer-executable instructions, wherein the computer-executable instructions invoke one or more application program components, comprising:
an e-commerce engine configured to execute one or more inputs from a buyer, seller, and/or owner, and transmit the one or more inputs to one or more further application program components;
a seller module providing a user interface for selling an item; for displaying an item for sale on an e-commerce marketplace user interface, and for responding to a buyer initiating a process for purchasing the item;
an owner module providing a user interface for monitoring an inventory of one or more items for sale on an e-commerce marketplace user interface;
an ambassador module providing a user interface for promoting the item or the e-commerce marketplace;
a revenue share engine configured to determine how a portion of revenue generated on the e-commerce marketplace is distributed;
a seller database for storing data associated with the item offered for sale;
an owner database for storing data associated with the item offered for sale;
a buyer database for storing data associated with a buyer and a transaction;
a revenue database for storing data associated with the sale of the item;
an item database for storing data associated with the items offered for sale;
a member database for storing data associated with a user of the system; and
an ambassador database for storing data associated with a promoter's effort to promote the sale of the item or the system;
wherein the computer-executable instructions comprise:
providing an online social network system;
receiving revenue to be distributed among one or more users of the online social network system;
collecting data associated with the revenue received;
determining which users of the one or more users are associated with the revenue received;
determining a plurality of attributes for each of the one or more users;
wherein, for each particular attribute of the plurality of attributes, calculating a metric value for each of the one or more users who have the particular user attribute, based on the collected data;
determining a plurality of revenue distribution rules based on the calculated metric value for the one or more users having the user attribute;
storing the determined plurality of revenue distribution rules;
generating a revenue distribution schedule by examining the stored plurality of revenue distribution rules; and
distributing the revenue received to the one or more users according to the revenue distribution schedule.

20. The system of claim 19, wherein the data associated with the item offered for sale comprises the user selling the item, the item offered for sale, a price of the item, a length of time the item was for sale, and a number of user who viewed the item for sale;
wherein the data associated with a buyer and a transaction comprises the user buying the item, the item offered for sale, and the price of the item; and
wherein the data associated with the sale of the item comprises a service fee associated with the sale of the item, the price paid for the item, and a ledger for each sale associated with a particular user.
